(19) United States
(12) Patent Application Publication
(10) Pub. No.: US 2022/0164684 A1
(43) Pub. Date: May 26, 2022

(54) PREDICTING METHOD OF WILDFIRE PROPAGATION AREAS AND SYSTEM THEREOF

(71) Applicant: NATIONAL TSING HUA UNIVERSITY, Hsinchu (TW)

(72) Inventor: Wei-Chang YEH, Hsinchu (TW)

(21) Appl. No.: 17/226,070

(22) Filed: Apr. 8, 2021

(30) Foreign Application Priority Data
Nov. 24, 2020 (TW) 109141197

(51) Int. Cl. G06N 5/04; G06N 7/00; G06N 5/00

(52) U.S. Cl. CPC G06N 5/04; G06N 5/003; G06N 7/005

(57) ABSTRACT

A predicting method of a plurality of wildfire propagation areas includes a network constructing step, a normalized adjacency matrix constructing step, a node ranking value calculating step, a state ranking value calculating step, a source node determining step and an occurrence probability calculating step. The node ranking value calculating step is performed to calculate a ranking value and a plurality of states of each of the nodes. The normalized adjacency matrix constructing step is performed to construct a normalized matrix. The state ranking value calculating step is performed to calculate a state ranking value and a state probability of each of the nodes. The source node determining step is performed to determine a source node of the wildfire propagation areas and the states corresponding to the source node. The occurrence probability calculating step is performed to calculate the occurrence probability of the wildfire propagation areas.

### RELATED APPLICATIONS

This application claims priority to Taiwan Application Serial Number 109141197, filed Nov. 24, 2020, which is herein incorporated by reference.

### BACKGROUND

### Technical Field

The present disclosure relates to a predicting method and a system thereof. More particularly, the present disclosure relates to a predicting method of a plurality of wildfire propagation areas and a system thereof.

### Description of Related Art

The range, frequency and complexity of a wildfire have been increased sharply. The wildfire is a non-structural and irregular phenomenon, which is occurred in the wild. The wildfire often occurs in the place close to human and nature, and it leads to serious damage, air pollution, damage of the plants and forest and high death toll. Accompanying with the global warming, the occurrence probability of the wildfire increases 15% while the temperature increases 1 degree, the wildfire will also rise the temperature, and then occurrence probability of the wildfire will increase and form a vicious cycle.

The wildfire is a serious practical problem, and is not always occurred in the same area (e.g., city), and the wildfire will propagate to adjacency area. The wildfire is affected by the weather (e.g., wind or rain), surface type (e.g., forest or lake) of the position. Hence, the occurrence probability of the wildfire is different from the conventional path probability problems (all the events occur in the paths and occur in regular destination), the occurrence probability of the wildfire needs to be calculated by a specific method to evaluate the propagating result and the occurrence probability. Thus, a predicting method and a predicting system of a plurality of the wildfire propagation areas can be served as a fast, simple, effective and reliable tool in predicting the occurrence probability are commercially desirable.

### SUMMARY

According to one aspect of the present disclosure, a method of a plurality of wildfire propagation areas is configured to predict an occurrence probability of the wildfire propagation areas in a network. The predicting method of the plurality of wildfire propagation areas includes a network constructing step, a normalized adjacency matrix constructing step, a node ranking value calculating step, a state ranking value calculating step, a source node determining step and an occurrence probability calculating step. The network constructing step is performed to construct a plurality of nodes and a plurality of links connected to the nodes in the network. The normalized adjacency matrix constructing step is performed to construct a normalized adjacency matrix according to the nodes and the links of the network. The node ranking value calculating step is performed to calculate a ranking value of each of the nodes according to a degree of each of the nodes, and find out a plurality of states of each of the nodes. The degree represents a number of the links connected to each of the nodes. The state ranking value calculating step is performed to calculate a state ranking value and a state probability of each of the nodes according to the ranking value and the states of each of the nodes. The source node determining step is performed to determine a source node of the wildfire propagation areas and the states corresponding to the source node according to a largest one of the state ranking values of the nodes. The occurrence probability calculating step is performed to enumerate all the states corresponding to the source node by a dynamic binary-addition tree algorithm, and calculate the occurrence probability of the wildfire propagation areas corresponding to the source node according to the state probability.

According to another aspect of the present disclosure, a predicting system of a plurality of wildfire propagation areas is configured to predict an occurrence probability of the wildfire propagation areas in a network. The predicting system of the plurality of wildfire propagation areas includes a memory and a processing unit. The memory is configured to access the network and a dynamic binary-addition tree algorithm. The network includes a plurality of nodes and a plurality of links connected to the nodes. The processing unit is electrically connected to the memory and receives the network and the dynamic binary-addition tree algorithm, and the processing unit is configured to implement a predicting method of the plurality of wildfire propagation areas including performing a network constructing step, a normalized adjacency matrix constructing step, a node ranking value calculating step, a state ranking value calculating step, a source node determining step and an occurrence probability calculating step. The network constructing step is performed to construct the nodes and the links connected to the nodes in the network. The normalized adjacency matrix constructing step is performed to construct a normalized adjacency matrix according to the nodes and the links of the network. The node ranking value calculating step is performed to calculate a ranking value of each of the nodes according to a degree of each of the nodes, and find out a plurality of states of each of the nodes. The degree represents a number of the links connected to each of the nodes. The state ranking value calculating step is performed to calculate a state ranking value and a state probability of each of the nodes according to the ranking value and the states of each of the nodes. The source node determining step is performed to determine a source node of the wildfire propagation areas and the states corresponding to the source node according to a largest one of the state ranking values of the nodes. The occurrence probability calculating step is performed to enumerate all the states corresponding to the source node by the dynamic binary-addition tree algorithm, and calculate the occurrence probability of the wildfire propagation areas corresponding to the source node according to the state probability.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a method of a plurality of wildfire propagation areas according to a first embodiment of the present disclosure.

FIG. 2 shows a flow chart of a method of a plurality of wildfire propagation areas according to a second embodiment of the present disclosure.

FIG. 3 shows a schematic view of a network of the method of the plurality of wildfire propagation areas of FIG. 2.

FIG. 4 shows a block diagram of a system of a plurality of wildfire propagation areas according to a third embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

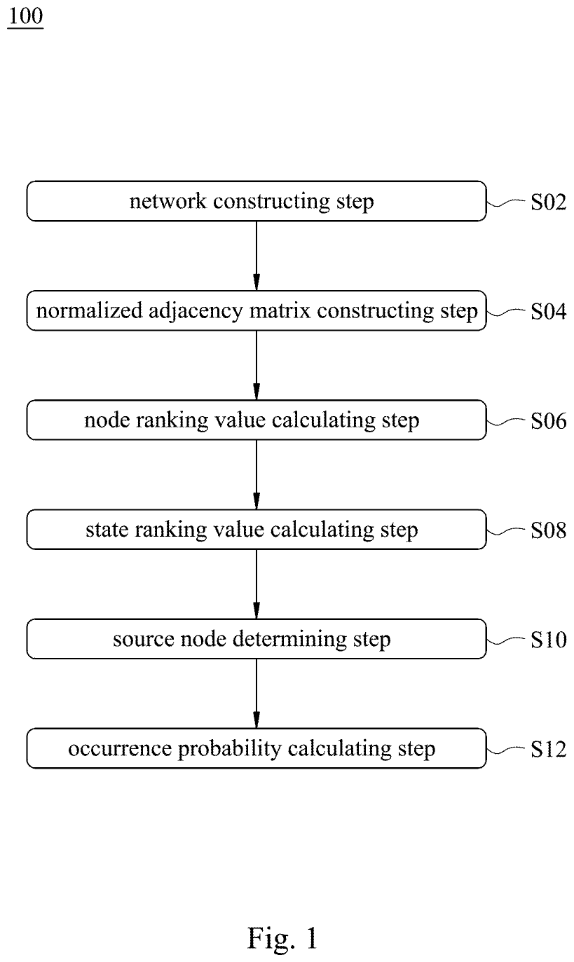

Please refer to FIG. 1. FIG. 1 shows a flow chart of a method 100 of a plurality of wildfire propagation areas according to a first embodiment of the present disclosure. The predicting method 100 of the plurality of wildfire propagation areas is configured to predict an occurrence probability of the wildfire propagation areas in a network, and includes a network constructing step S02, a normalized adjacency matrix constructing step S04, a node ranking value calculating step S06, a state ranking value calculating step S08, a source node determining step S10 and an occurrence probability calculating step S12.

The network constructing step S02 is performed to construct a plurality of nodes and a plurality of links connected to the nodes in the network. The normalized adjacency matrix constructing step S04 is performed to construct a normalized adjacency matrix according to the nodes and the links of the network. The node ranking value calculating step S06 is performed to calculate a ranking value of each of the nodes according to a degree of each of the nodes, and find out a plurality of states of each of the nodes. The degree represents a number of the links connected to each of the nodes. The state ranking value calculating step S08 is performed to calculate a state ranking value and a state probability of each of the nodes according to the ranking value and the states of each of the nodes. The source node determining step S10 is performed to determine a source node of the wildfire propagation areas and the states corresponding to the source node according to a largest one of the state ranking values of the nodes. The occurrence probability calculating step S12 is performed to enumerate all the states corresponding to the source node by a dynamic binary-addition tree algorithm, and calculate the occurrence probability of the wildfire propagation areas corresponding to the source node according to the state probability. Thus, the predicting method 100 of the plurality of wildfire propagation areas can be served as a fast, simple, effective and reliable tool in predicting the occurrence probability of the wildfire propagation areas in a scale-free network by the dynamic binary-addition tree algorithm. Moreover, the areas or the nodes (e.g., cities or important strongholds) which should be protected can be determined immediately by the occurrence probability of the wildfire propagation areas, thereby having a significant contribution to the prediction of the propagation of the wildfire and the disaster prevention. Each of the steps of the predicting method 100 of the plurality of wildfire propagation areas is described in more detail below.

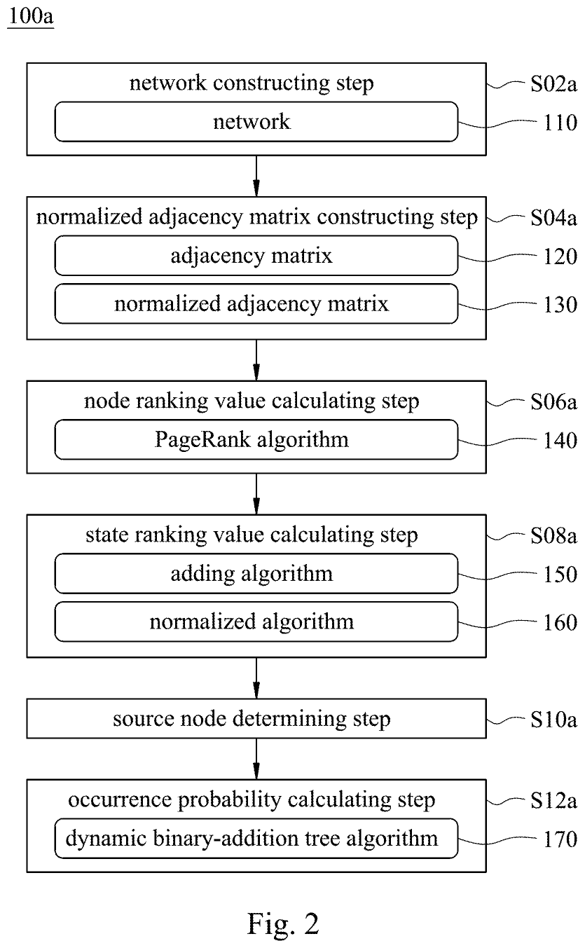

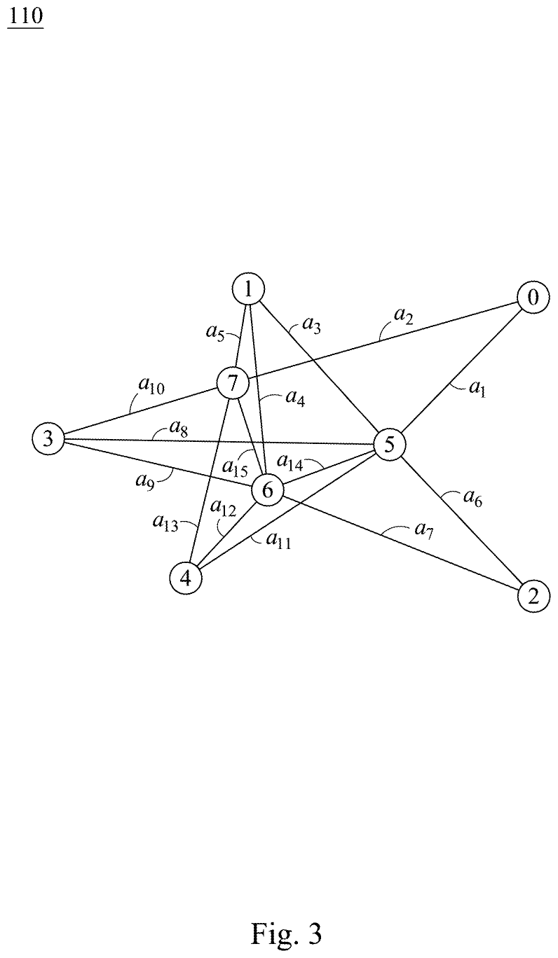

Please refer to FIG. 2 and FIG. 3. FIG. 2 shows a flow chart of a method 100a of a plurality of wildfire propagation areas according to a second embodiment of the present disclosure. FIG. 3 shows a schematic view of a network 110 of the method 100a of the plurality of wildfire propagation areas of FIG. 2. In FIG. 2 and FIG. 3, the predicting method 100a is configured to predict an occurrence probability Pr(i, Nₐᵣₑₐ) of the wildfire propagation areas in a network 110, and includes a network constructing step S02a, a normalized adjacency matrix constructing step S04a, a node ranking value calculating step S06a, a state ranking value calculating step S08a, a source node determining step S10a and an occurrence probability calculating step S12a.

The network constructing step S02a is performed to construct a plurality of nodes 0, 1, 2, 3, 4, 5, 6, 7 and a plurality of links a₁, a₂, a₃, a₄, a₅, a₆, a₇, a₈, a₉, a₁₀, a₁₁, a₁₂, a₁₃, a₁₄, a₁₅ connected to the nodes 0-7 in the network 110. The network 110 is a scale-free network. The nodes 0-7 are corresponding to the entity locations (e.g., cities or important strongholds), respectively.

The normalized adjacency matrix constructing step S04a is performed to construct a normalized adjacency matrix 130 according to the nodes 0-7 and the links a₁-a₁₅ of the network 110. In detail, the normalized adjacency matrix constructing step S04a includes steps S042, S044. The step S042 is performed to construct an adjacency matrix 120 according to the nodes i (i=0-7) and the links a₁-a₁₅ of the network 110, and the adjacency matrix 120 includes the degree Deg(i) of each of the nodes i. The adjacency matrix 120 of the present disclosure is listed in Table 1. The step S044 is performed to construct the normalized adjacency matrix 130 according to the degree Deg(i) of each of the nodes i of the adjacency matrix 120, and the normalized adjacency matrix 130 is listed in Table 2.

TABLE 1

| i | 0 | 1 | 2 | 3 | 4 | 5 | 6 | 7 |
|---|---|---|---|---|---|---|---|---|
| 0 | | — | — | — | — | 1 | — | 1 |
| 1 | — | | — | — | — | 1 | 1 | 1 |
| 2 | — | — | | — | — | 1 | 1 | — |
| 3 | — | — | — | | — | 1 | 1 | 1 |
| 4 | — | — | — | — | | 1 | 1 | 1 |
| 5 | 1 | 1 | 1 | 1 | 1 | | 1 | — |
| 6 | — | 1 | 1 | 1 | 1 | 1 | | 1 |
| 7 | 1 | 1 | — | 1 | 1 | — | 1 | |
| Deg(i) | 2 | 3 | 2 | 3 | 3 | 6 | 6 | 5 |

TABLE 2

| 1 | 0 | 1 | 2 | 3 | 4 | 5 | 6 | 7 |
|---|---|---|---|---|---|---|---|---|
| 0 | 0 | 0 | 0 | 0 | 0 | 0.16̅ | 0 | 0.2 |
| 1 | 0 | 0 | 0 | 0 | 0 | 0.16̅ | 0.16̅ | 0.2 |
| 2 | 0 | 0 | 0 | 0 | 0 | 0.16̅ | 0.16̅ | 0 |
| 3 | 0 | 0 | 0 | 0 | 0 | 0.16̅ | 0.16̅ | 0.2 |
| 4 | 0 | 0 | 0 | 0 | 0 | 0.16̅ | 0.16̅ | 0.2 |
| 5 | 0.5 | 0.3̅ | 0.5 | 0.3̅ | 0.3̅ | 0 | 0.16̅ | 0 |
| 6 | 0 | 0.3̅ | 0.5 | 0.3̅ | 0.3̅ | 0.16̅ | 0 | 0.2 |
| 7 | 0.5 | 0.3̅ | 0 | 0.3̅ | 0.3̅ | 0 | 0.16̅ | 0 |

The node ranking value calculating step S06a is performed to calculate a ranking value of each of the nodes i according to a degree Deg(i) of each of the nodes i, and find out a plurality of states of each of the nodes i, and the degree represents a number of the links (such as a part of a₁-a₁₅) connected to each of the nodes i. In detail, the node ranking value calculating step S06a includes executing an iterative computation to adjust the ranking value of each of the nodes i according to a PageRank algorithm 140 and the degree Deg(i) of each of the nodes i, and checking whether the ranking value achieves a convergent state. In response to determining that the ranking value achieves the convergent state, performing the state ranking value calculating step S08a. In response to determining that the ranking value does not achieve the convergent state, repeating executing the iterative computation to adjust the ranking value of each of the nodes i according to the PageRank algorithm 140 and the degree Deg(i) of each of the nodes i. The convergent state represents that the ranking value before adjusting is equal to the ranking value after adjusting in the iterative computation. In other words, the ranking value after adjusting in the iterative computation approaches and remains at a constant value. The ranking value is represented as PR(i), and the PageRank algorithm 140 is a ranking algorithm and is satisfied by a formula (1).

PR(i)=(1−d)+d×[PR(i₁)/Degₒᵤₜ(i₁)+ . . . +PR(iₙ)/Degₒᵤₜ(iₙ)] (1).

d is represented as a damping factor, and d can be set to 0.85. Degₒᵤₜ(i₁), Degₒᵤₜ(iₙ) are represented as numbers of an out-degree of the link connected to the nodes iₙ, respectively.

The states are represented as a condition of the wildfire of the nodes i which is propagated. For example, in FIG. 3, the state of the node 0 includes empty set ø, {5}, {7} and {5, 7}. The empty set ø represents that the wildfire occurs on the node 0 and the wildfire does not propagate to other nodes i. {5} represents that the wildfire propagates from the node 0 to the node 5, but the wildfire dose not propagate to the node 7. {7} represents that the wildfire propagates from the node 0 to the node 7, but the wildfire does not propagate to the node 5. {5, 7} represents the wildfire propagating from the node 0 to the nodes 5, 7.

Table 3 lists the degree Deg(i), an adjacency node set V(i), a state number C(i), the ranking value PR(i) and the maximum ranking value PR(V(i)) of the nodes i. The adjacency node set V(i) represents a set of the nodes i which may propagate. The state number C(i) represents a number of the state. The maximum ranking value PR(V(i)) represents a maximum of the ranking value PR(i).

TABLE 3

| 1 | Deg(i) | V(i) | C(i) | PR(i) | PR(V(i)) | 1-PR(V(i)) |
|---|---|---|---|---|---|---|
| 0 | 2 | {7, 5} | 4 | 0.074066 | 0.357809 | 0.642191 |
| 1 | 3 | {7, 6, 5} | 8 | 0.101160 | 0.549056 | 0.450944 |
| 2 | 2 | {7, 6} | 4 | 0.073398 | 0.357809 | 0.642191 |
| 3 | 3 | {7, 6, 5} | 8 | 0.101160 | 0.549056 | 0.450944 |
| 4 | 3 | {7, 6, 5} | 8 | 0.101160 | 0.549056 | 0.450944 |
| 5 | 6 | {6, 4, 3, 2, 1, 0} | 64 | 0.194502 | 0.642191 | 0.357809 |
| 6 | 6 | {7, 5, 4, 3, 2, 1} | 64 | 0.191247 | 0.734687 | 0.265313 |
| 7 | 5 | {6, 4, 3, 1, 0} | 32 | 0.163307 | 0.568793 | 0.431207 |

Table 4 lists the top eight states of the nodes i in FIG. 3, and the state label SL represents a value of the state position of each of the nodes i. The state label SL can be represented in binary or decimal. For instance, the degree Deg(0) of the node 0 in FIG. 3 is 2, the adjacency node set V(0) is {7, 5}, and the states of the node 0 include the empty set 0, {5}, {7} and {5, 7}. If the state label SL is represented in binary, the empty set 0, {5}, {7}, {5, 7} can be represented by 00, 01, 10, 11, respectively. In other words, the first bit and the second bit of the binary state label SL are corresponding to the node 7 and the node 5 of the adjacency node set V(0), respectively. Furthermore, the state label SL also can be represented in decimal. For instance, the empty set 0, {5}, {7}, {5, 7} can be represented by 0, 1, 2, 3, respectively, and 0, 1, 2, 3 of the decimal are corresponding to 00, 01, 10, 11 of the binary respectively, as listed in Table 4. Moreover, Sₖ(i) represents a state of a kth one of the state labels SL of the nodes i. k represents an integer between 0 and 2^{|Deg(i)|}−1, for instance, S₀(0)=ø, S₁(1)={5}, S₃(2)={6, 7}, S₂(4)={6}, S₄(5)={0, 1}, S₃(6)={3}, S₇(3)={5, 6, 7}. Moreover, the state vector X represents a wildfire propagating sequence, and the state vector X includes the nodes i and the state labels SL corresponding to the nodes i. A source node and a sink node can be observed by the state vector X. For instance, a state vector X(1/3, 1/5, 0/0) includes the nodes 3, 5, 0 and the state labels SL corresponding to the nodes 3, 5, 0. The three state labels SL are 1, 1, 0. In the state vector X(1/3, 1/5, 0/0), the source node is the node 3, the node 3 will propagate to the node 5, the node 5 will propagate to the node 0, the node 0 is the sink node, and (1/3, 1/5, 0/0) are corresponding to S₁(3)={5}, S₁(5)={0} and S₀(0)=ø.

TABLE 4

| | SL | | | | | | | |
|---|---|---|---|---|---|---|---|---|
| i | 0 | 1 | 2 | 3 | 4 | 5 | 6 | 7 |
| 0 | Ø | {5} | {7} | {5, 7} | — | — | — | — |
| 1 | Ø | {5} | {6} | {7} | {5, 6} | {5, 7} | {6, 7} | {5, 6, 7} |
| 2 | Ø | {5} | {6} | {6, 7} | — | — | — | — |
| 3 | Ø | {5} | {6} | {7} | {5, 6} | {5, 7} | {6, 7} | {5, 6, 7} |
| 4 | Ø | {5} | {6} | {7} | {5, 6} | {5, 7} | {6, 7} | {5, 6, 7} |
| 5 | Ø | {0} | {1} | {2} | {0, 1} | {0, 2} | {1, 2} | {0, 1, 2} |
| 6 | Ø | {1} | {2} | {3} | {1, 2} | {1, 3} | {2, 3} | {1, 2, 3} |
| 7 | Ø | {0} | {1} | {3} | {0, 1} | {0, 3} | {1, 3} | {0, 1, 3} |

The state ranking value calculating step S08a is performed to calculate a state ranking value PR(Sₖ(i)) and a state probability Pr(Sₖ(i)) of each of the nodes i according to the ranking value and the states of each of the nodes i. In detail, the state ranking value calculating step S08a includes steps S082, S084. The step S082 is performed to calculate the state ranking value PR(Sₖ(i)) of each of the nodes i according to an adding algorithm 150, the ranking value of each of the nodes i and the states. The adding algorithm 150 is satisfied by a formula (2).

$$P R ( {S}_{k} ( i ) ) = {\sum }_{\vert {S}_{j} ( i ) \vert = 1 and {S}_{j} ( i ) ⊆ {S}_{k} ( i )} P R ( {S}_{j} ( i ) ) . \qquad ( 2 )$$

j is represented as an integer between 0 and 2^{|Deg(i)|}−1. Table 5 lists the top eight state ranking values PR(Sₖ(i)), and the state ranking values PR(Sₖ(i)) are calculated by the formula (2) and the states of the nodes i.

TABLE 5

| i | 0 | 1 | 2 | 3 | 4 | 5 | 6 | 7 |
|---|---|---|---|---|---|---|---|---|
| 0 | 0.0816538 | 0.194502 | 0.163308 | 0.357809 | — | — | — | — |
| 1 | 0.0816538 | 0.194502 | 0.191247 | 0.385748 | 0.163308 | 0.357809 | 0.354554 | 0.549056 |
| 2 | 0.0956233 | 0.194502 | 0.191247 | 0.385748 | — | — | — | — |
| 3 | 0.0816538 | 0.194502 | 0.191247 | 0.385748 | 0.163308 | 0.357809 | 0.354554 | 0.549056 |
| 4 | 0.0816538 | 0.194502 | 0.191247 | 0.385748 | 0.163308 | 0.357809 | 0.354554 | 0.549056 |
| 5 | 0.0366988 | 0.0740667 | 0.10116 | 0.175227 | 0.0733977 | 0.147464 | 0.174558 | 0.248624 |
| 6 | 0.0366988 | 0.10116 | 0.0733977 | 0.174558 | 0.10116 | 0.20232 | 0.174558 | 0.275718 |
| 7 | 0.0370333 | 0.0740667 | 0.10116 | 0.175227 | 0.10116 | 0.175227 | 0.20232 | 0.276387 |

The step S084 is performed to calculate the state probability Pr(Sₖ(i)) of each of the nodes i according to a normalized algorithm 160 and the state ranking value PR(Sₖ(i)) of each of the nodes i. The normalized algorithm 160 is satisfied by a formula (3).

$$P R ( {S}_{k} ( i ) ) = \frac{P r ( {S}_{k} ( i ) )}{{\sum }_{i = 0}^{{2}^{\vert Deg ( i ) \vert} - 1} P R ( {S}_{k} ( i ) )} . \qquad ( 3 )$$

Moreover, Table 6 and Table 7 list the top eight state probability Pr(Sₖ(i)) of the nodes i, and the state ranking values PR(Sₖ(i)) are calculated by the formula (3) and the states of the nodes i.

Table 6

| i | 0 | 1 | 2 | 3 |
|---|---|---|---|---|
| 0 | 0.10241600 | 0.24395900 | 0.20483300 | 0.44879200 |
| 1 | 0.03584640 | 0.08538720 | 0.08395830 | 0.16934600 |
| 2 | 0.11027700 | 0.22430800 | 0.22055400 | 0.44486200 |
| 3 | 0.03584640 | 0.08538720 | 0.08395830 | 0.16934600 |
| 4 | 0.03584640 | 0.08538720 | 0.08395830 | 0.16934600 |
| 5 | 0.00178264 | 0.00359777 | 0.00491382 | 0.00851160 |
| 6 | 0.00155856 | 0.00429615 | 0.00311711 | 0.00741326 |
| 7 | 0.00405280 | 0.00810559 | 0.01107060 | 0.01917620 |

Table 7

| i | 4 | 5 | 6 | 7 |
|---|---|---|---|---|
| 0 | — | — | — | — |
| 1 | 0.07169290 | 0.15708000 | 0.15565100 | 0.24103800 |
| 2 | — | — | — | — |
| 3 | 0.07169290 | 0.15708000 | 0.15565100 | 0.24103800 |
| 4 | 0.07169290 | 0.15708000 | 0.15565100 | 0.24103800 |
| 5 | 0.00356528 | 0.00716305 | 0.00847910 | 0.01207690 |
| 6 | 0.00429615 | 0.00859229 | 0.00741326 | 0.01170940 |
| 7 | 0.01107060 | 0.01917620 | 0.02214120 | 0.03024680 |

The source node determining step S10a is performed to determine a source node of the wildfire propagation areas and the states corresponding to the source node according to a largest one of the state ranking values PR(Sₖ(i)) of the nodes i.

The occurrence probability calculating step S12a is performed to enumerate all the states corresponding to the source node (one of the nodes i, i=0-7) by a dynamic binary-addition tree algorithm 170, and calculate the occurrence probability Pr(i, Nₐᵣₑₐ) of the wildfire propagation areas corresponding to the source node according to the state probability Pr(Sₖ(i)). In detail, the dynamic binary-addition tree algorithm 170 includes adding 1 to a binary value Bₖ corresponding to a state label SL of a state vector X including the source node to enumerate all the states corresponding to the source node. Moreover, the degree Deg(i) of the nodes i is an out-degree, the number(state number C(i)) is equal to 2^{|Deg(i)|}, and the binary value of the state corresponding to the state label SL is equal to Deg(i). The number of the nodes i is n, the nodes i are integers between 0 and n−1, Nₐᵣₑₐ is a positive integer between 1 and n. Table 8 lists the states enumerated when the source node is the node 0. Because the dynamic binary-addition tree algorithm 170 is performed by adding 1 to the binary value Bₖ corresponding to the state label SL of the state vector X of the source node, after the dynamic binary-addition tree algorithm 170 is performed, the result is equivalent to the binary value Bₖ corresponding to the state label SL of the previous state vector Xₖ add 1 to obtain a binary value Bₖ₊₁ corresponding to the state label SL of the present state vector Xₖ₊₁. The “dynamic” of the dynamic binary-addition tree algorithm 170 represents that the state vector X has different source nodes, and the state label SL of each of the node of the state vector X has binary values Bₖ with different binary number. Thus, the present disclosure can comprehensively enumerate all the possible state of the nodes i corresponding to the state vector X via the dynamic binary-addition tree algorithm 170, thereby simplifying program complexity, saving memory space and increasing efficiency and parallel processing.

Table 8

| SL | Bₖ | state |
|---|---|---|
| 0 | 00 | ø |
| 1 | 01 | {5} |
| 2 | 10 | {7} |
| 3 | 11 | {5, 7} |

Thus, the predicting method 100a of the plurality of wildfire propagation areas of the present disclosure can be served as a fast, simple, effective and reliable tool in predicting the occurrence probability Pr(i, Nₐᵣₑₐ) of the wildfire propagation areas in the scale-free network by the dynamic binary-addition tree algorithm 170. Moreover, the areas or the nodes i which should be protected can be determined immediately by the occurrence probability Pr(i, Nₐᵣₑₐ) of the wildfire propagation areas, thereby having a significant contribution to the prediction of the propagation of the wildfire and the disaster prevention.

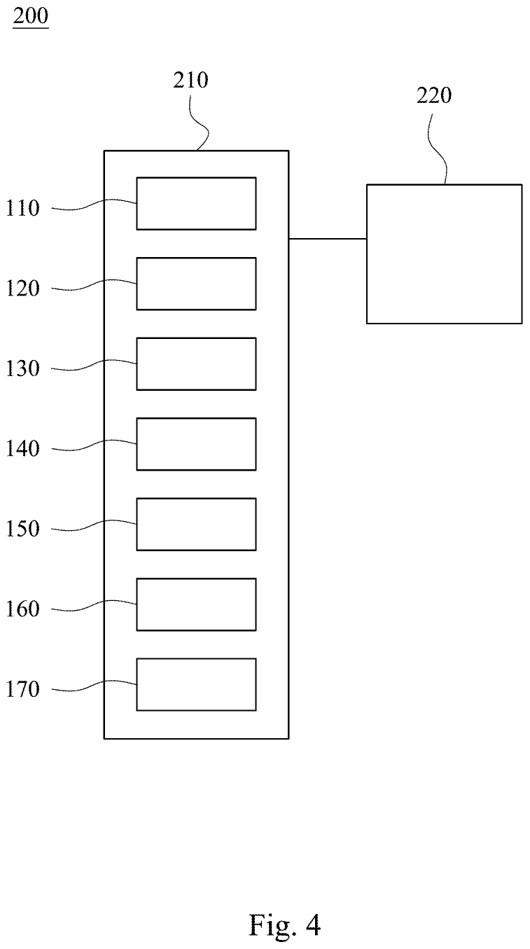

Please refer to FIG. 2 to FIG. 4. FIG. 4 shows a block diagram of a system 200 of a plurality of wildfire propagation areas according to a third embodiment of the present disclosure. The predicting system 200 of the plurality of wildfire propagation areas is configured to predict an occurrence probability Pr(i, Nₐᵣₑₐ) of the wildfire propagation areas in a network 110, the predicting system 200 of the plurality of wildfire propagation areas includes a memory 210 and a processing unit 220.

The memory 210 is configured to access the network 110, an adjacency matrix 120, a normalized adjacency matrix 130, a PageRank algorithm 140, an adding algorithm 150, a normalized algorithm 160 and a dynamic binary-addition tree algorithm 170. The network 110 includes a plurality of nodes 0-7 and a plurality of links a₁-a₁₅ connected to the nodes 0-7.

The processing unit 220 is electrically connected to the memory 210. The processing unit 220 receives the network 110, the PageRank algorithm 140, the adding algorithm 150, the normalized algorithm 160 and the dynamic binary-addition tree algorithm 170, and the processing unit 220 is configured to implement a predicting method 100a of the plurality of wildfire propagation areas including performing a network constructing step S02a, a normalized adjacency matrix constructing step S04a, a node ranking value calculating step S06a, a state ranking value calculating step S08a, a source node determining step S10a and an occurrence probability calculating step S12a. The processing unit 220 can be a microprocessor, a computer, a mobile communicating device, a network computing platform or other electronic processor, but the present disclosure is not limited thereto. Table 9 lists a predicting result of the system 200 of the plurality of wildfire propagation areas. A number of the nodes i is 8, the nodes i represent integers between 0 and 7, and Nₐᵣₑₐ is a positive integer between 1 and 8. The vector number represents a number of the state vector X, the simulation time represents a computing time of the processing unit 220 performed the predicting method 100a of the plurality of wildfire propagation areas to generate the occurrence probability Pr(i, Nₐᵣₑₐ) The processing unit 220 is a notebook Intel Core i7 central processor, installed a Windows 10 operating system and run on Spyder. The memory 210 is a 16 GB random access memory (RAM). In the predicting result of Table 9, the Nₐᵣₑₐ increases, the occurrence probability Pr(i, Nₐᵣₑₐ) decreases, and the vector number and the simulation time increases. In contrast to the Nₐᵣₑₐ, the vector number and the simulation time increase exponentially. Because the network 110 is a scale-free network, the degree distribution follows a power law, in other words, the predicting result of the propagation of the wildfire following the power law has proved that the propagation of the wildfire is the scale-free network. Thus, the predicting system 200 of the plurality of wildfire propagation areas of the present disclosure can be served as a fast, simple, effective and reliable tool in predicting the occurrence probability Pr(i, Nₐᵣₑₐ) of the wildfire propagation areas in the scale-free network by the dynamic binary-addition tree algorithm 170. Moreover, the areas or the nodes i which should be protected can be determined immediately by the occurrence probability Pr(i, Nₐᵣₑₐ) of the wildfire propagation areas, thereby having a significant contribution to the prediction of the propagation of the wildfire and the disaster prevention.

Table 9

| i | Nₐᵣₑₐ | Pr(i, Nₐᵣₑₐ) | vector number | simulation time |
|---|---|---|---|---|
| 0 | 1 | 1.0000000000 | 1 | 0.0000000000 |
| | 2 | 0.8975835388 | 5 | 0.0000000000 |
| | 3 | 0.8937805009 | 191 | 0.0029911995 |
| | 4 | 0.8895453875 | 1106 | 0.0109896660 |
| | 5 | 0.8863464307 | 18036 | 0.3772556782 |
| | 6 | 0.8775958395 | 356664 | 6.4483911991 |
| | 7 | 0.8283404518 | 7510836 | 84.4704558849 |
| | 8 | 0.5518110997 | 87742588 | 1131.3778553009 |
| 1 | 1 | 1.0000000000 | 1 | 0.0000000000 |
| | 2 | 0.9641535574 | 13 | 0.0000000000 |
| | 3 | 0.9620059754 | 324 | 0.0066373348 |
| | 4 | 0.9586257553 | 2607 | 0.0215830803 |
| | 5 | 0.9524496834 | 36276 | 0.3242473602 |
| | 6 | 0.9349168701 | 773828 | 6.7790575027 |
| | 7 | 0.8529978662 | 13814130 | 152.8260827065 |
| | 8 | 0.5144439304 | 122668428 | 1591.6093254089 |
| 2 | 1 | 1.0000000000 | 1 | 0.0000000000 |
| | 2 | 0.8897230515 | 5 | 0.0000000000 |
| | 3 | 0.8874922357 | 255 | 0.0156233311 |
| | 4 | 0.8840045523 | 1654 | 0.0312418938 |
| | 5 | 0.8781593396 | 21394 | 0.5269286633 |
| | 6 | 0.8646503517 | 415994 | 8.5190973282 |
| | 7 | 0.8158048522 | 8604502 | 117.4727280140 |
| | 8 | 0.5484221919 | 95178046 | 1374.0696630478 |
| 3 | 1 | 1.0000000000 | 1 | 0.0000000000 |
| | 2 | 0.9641535574 | 13 | 0.0000000000 |
| | 3 | 0.9620059754 | 324 | 0.0000000000 |
| | 4 | 0.9586257553 | 2607 | 0.0312414169 |
| | 5 | 0.9524496834 | 36212 | 0.3466234207 |
| | 6 | 0.9349168701 | 771940 | 7.1046669483 |
| | 7 | 0.8529978662 | 13797962 | 167.7595953941 |
| | 8 | 0.5144439304 | 122821892 | 3518.9256913662 |
| 4 | 1 | 1.0000000000 | 1 | 0.0000000000 |
| | 2 | 0.9641535574 | 13 | 0.0000000000 |
| | 3 | 0.9620059754 | 324 | 0.0039894581 |
| | 4 | 0.9586257553 | 2607 | 0.0259304047 |
| | 5 | 0.9524496834 | 36180 | 0.3457112312 |
| | 6 | 0.9349168701 | 771732 | 7.0750279427 |
| | 7 | 0.8529978662 | 13791562 | 156.8019413948 |
| | 8 | 0.5144439304 | 123244356 | 1742.5730378628 |
| 5 | 1 | 1.0000000000 | 1 | 0.0000000000 |
| | 2 | 0.9948807055 | 252 | 0.0029914379 |
| | 3 | 0.9865077998 | 594 | 0.0059838295 |
| | 4 | 0.9798225431 | 8664 | 0.0752079487 |
| | 5 | 0.9695962486 | 119914 | 1.0816006660 |
| | 6 | 0.9426437460 | 2050424 | 18.7956511974 |
| | 7 | 0.8305539996 | 26321044 | 339.0854218006 |
| | 8 | 0.4627796376 | 183961358 | 2505.2812619209 |
| 6 | 1 | 1.0000000000 | 1 | 0.0000000000 |
| | 2 | 0.9984414429 | 125 | 0.0019941330 |
| | 3 | 0.9956013853 | 355 | 0.0049867630 |
| | 4 | 0.9916215500 | 5216 | 0.0767943859 |
| | 5 | 0.9814653606 | 70006 | 1.1723952293 |
| | 6 | 0.9572730499 | 1153321 | 18.1137840748 |
| | 7 | 0.8551777678 | 14700763 | 178.0699036121 |
| | 8 | 0.4911080546 | 120803944 | 1547.1873717308 |
| 7 | 1 | 1.0000000000 | 1 | 0.0000000000 |
| | 2 | 0.9899554655 | 124 | 0.0020000935 |
| | 3 | 0.9787289429 | 456 | 0.0069758892 |
| | 4 | 0.9725299052 | 7998 | 0.1595721245 |
| | 5 | 0.9650027124 | 130986 | 1.8445804119 |
| | 6 | 0.9451637239 | 2571160 | 35.2290692329 |
| | 7 | 0.8385918158 | 29212442 | 461.0611312389 |
| | 8 | 0.4679529108 | 179307046 | 2957.6422238350 |

According to the aforementioned embodiments and examples, the advantages of the present disclosure are described as follows.

1. The predicting method and the system of the plurality of wildfire propagation areas of the present disclosure can be served as the fast, simple, effective and reliable tool in predicting the occurrence probability of the wildfire propagation areas in the scale-free network by the dynamic binary-addition tree algorithm.

2. The areas or the nodes which should be protected can be determined immediately by the occurrence probability of the wildfire propagation areas, thereby having a significant contribution to the prediction of the propagation of the wildfire and the disaster prevention.

3. Enumerating all the possible state of the nodes corresponding to the state vector comprehensively via the dynamic binary-addition tree algorithm, thereby simplifying program complexity, saving memory space and increasing efficiency and parallel processing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A predicting method of a plurality of wildfire propagation areas, which is configured to predict an occurrence probability of the wildfire propagation areas in a network, the predicting method of the plurality of wildfire propagation areas comprising:
performing a network constructing step to construct a plurality of nodes and a plurality of links connected to the nodes in the network;
performing a normalized adjacency matrix constructing step to construct a normalized adjacency matrix according to the nodes and the links of the network;
performing a node ranking value calculating step to calculate a ranking value of each of the nodes according to a degree of each of the nodes, and find out a plurality of states of each of the nodes, wherein the degree represents a number of the links connected to each of the nodes;
performing a state ranking value calculating step to calculate a state ranking value and a state probability of each of the nodes according to the ranking value and the states of each of the nodes;
performing a source node determining step to determine a source node of the wildfire propagation areas and the states corresponding to the source node according to a largest one of the state ranking values of the nodes; and
performing an occurrence probability calculating step to enumerate all the states corresponding to the source node by a dynamic binary-addition tree algorithm, and calculate the occurrence probability of the wildfire propagation areas corresponding to the source node according to the state probability.

2. The predicting method of the plurality of wildfire propagation areas of claim 1, wherein the network is a scale-free network.

3. The predicting method of the plurality of wildfire propagation areas of claim 1, wherein the normalized adjacency matrix constructing step comprises:
constructing an adjacency matrix according to the nodes and the links of the network, wherein the adjacency matrix comprises the degree of each of the nodes; and
constructing the normalized adjacency matrix according to the degree of each of the nodes of the adjacency matrix.

4. The predicting method of the plurality of wildfire propagation areas of claim 1, wherein the node ranking value calculating step comprises:
executing an iterative computation to adjust the ranking value of each of the nodes according to a PageRank algorithm and the degree of each of the nodes, and checking whether the ranking value achieves a convergent state;
in response to determining that the ranking value achieves the convergent state, performing the state ranking value calculating step;
in response to determining that the ranking value does not achieve the convergent state, repeating executing the iterative computation to adjust the ranking value of each of the nodes according to the PageRank algorithm and the degree of each of the nodes;
wherein the convergent state represents that the ranking value before adjusting is equal to the ranking value after adjusting in the iterative computation.

5. The predicting method of the plurality of wildfire propagation areas of claim 1, wherein the state ranking value calculating step comprises:
calculating the state ranking value of each of the nodes according to an adding algorithm, the ranking value of each of the nodes and the states; and
calculating the state probability of each of the nodes according to a normalized algorithm and the state ranking value of each of the nodes.

6. The predicting method of the plurality of wildfire propagation areas of claim 1, wherein the dynamic binary-addition tree algorithm comprises:
adding 1 to a binary value corresponding to a state label of a state vector comprising the source node to enumerate all the states corresponding to the source node.

7. The predicting method of the plurality of wildfire propagation areas of claim 6, wherein the degree is an out-degree, and is represented as Deg(i), the nodes are represented as i, a number of the states is equal to 2^{|Deg(i)|}, and a bit number of the binary value corresponding to the state label is equal to Deg(i).

8. A predicting system of a plurality of wildfire propagation areas, which is configured to predict an occurrence probability of the wildfire propagation areas in a network, the predicting system of the plurality of wildfire propagation areas comprising:
a memory configured to access the network and a dynamic binary-addition tree algorithm, wherein the network comprises a plurality of nodes and a plurality of links connected to the nodes; and
a processing unit electrically connected to the memory, wherein the processing unit receives the network and the dynamic binary-addition tree algorithm and is configured to implement a predicting method of the plurality of wildfire propagation areas comprising:
performing a network constructing step to construct the nodes and the links connected to the nodes in the network;
performing a normalized adjacency matrix constructing step to construct a normalized adjacency matrix according to the nodes and the links of the network;
performing a node ranking value calculating step to calculate a ranking value of each of the nodes according to a degree of each of the nodes, and find out a plurality of states of each of the nodes, wherein the degree represents a number of the links connected to each of the nodes;
performing a state ranking value calculating step to calculate a state ranking value and a state probability of each of the nodes according to the ranking value and the states of each of the nodes;
performing a source node determining step to determine a source node of the wildfire propagation areas and the states corresponding to the source node according to a largest one of the state ranking values of the nodes; and
performing an occurrence probability calculating step to enumerate all the states corresponding to the source node by the dynamic binary-addition tree algorithm, and calculate the occurrence probability of the wildfire propagation areas corresponding to the source node according to the state probability.

9. The predicting system of the plurality of wildfire propagation areas of claim 8, wherein the network is a scale-free network.

10. The predicting system of the plurality of wildfire propagation areas of claim 8, wherein the normalized adjacency matrix constructing step comprises:
constructing an adjacency matrix according to the nodes and the links of the network, wherein the adjacency matrix comprises the degree of each of the nodes; and
constructing the normalized adjacency matrix according to the degree of each of the nodes of the adjacency matrix.

11. The predicting system of the plurality of wildfire propagation areas of claim 8, wherein the node ranking value calculating step comprises:
executing an iterative computation to adjust the ranking value of each of the nodes according to a PageRank algorithm and the degree of each of the nodes, and checking whether the ranking value achieves a convergent state;
in response to determining that the ranking value achieves the convergent state, performing the state ranking value calculating step;
in response to determining that the ranking value does not achieve the convergent state, repeating executing the iterative computation to adjust the ranking value of each of the nodes according to the PageRank algorithm and the degree of each of the nodes;
wherein the convergent state represents that the ranking value before adjusting is equal to the ranking value after adjusting in the iterative computation.

12. The predicting system of the plurality of wildfire propagation areas of claim 8, wherein the state ranking value calculating step comprises:
calculating the state ranking value of each of the nodes according to an adding algorithm, the ranking value of each of the nodes and the states; and
calculating the state probability of each of the nodes according to a normalized algorithm and the state ranking value of each of the nodes.

13. The predicting system of the plurality of wildfire propagation areas of claim 8, wherein the dynamic binary-addition tree algorithm comprises:
adding 1 to a binary value corresponding to a state label of a state vector comprising the source node to enumerate all the states corresponding to the source node.

14. The predicting system of the plurality of wildfire propagation areas of claim 13, wherein the degree is an out-degree, and is represented as Deg(i), the nodes are represented as i, a number of the states is equal to 2^{|Deg(i)|}, and a bit number of the binary value corresponding to the state label is equal to Deg(i).
